(19) United States
(12) Patent Application Publication
(10) Pub. No.: US 2010/0008091 A1
(43) Pub. Date: Jan. 14, 2010

(54) FLUORESCENT LAMP HAVING BULB WHOSE END PORTION TO WHICH STEM MOUNT IS WELDED, AND A LIGHTING APPARATUS HAVING THE FLUORESCENT LAMP

(76) Inventors: Shiro IIDA, Kyoto (JP); Noriyuki UCHIDA, Osaka (JP); Katsuyuki NAGAHAMA, Osaka (JP); Hiromi TANAKA, Osaka (JP); Masahiro MIKI, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/502,065

(22) Filed: Jul. 13, 2009

(30) Foreign Application Priority Data
Jul. 14, 2008 (JP) 2008-182628

(51) Int. Cl. F21V 21/00; H01J 61/44; F21K 2/00

(52) U.S. Cl. 362/249.14; 313/493; 362/416

(57) ABSTRACT

A fluorescent lamp has a bulb, a phosphor layer and a base. The bulb has a tubular portion and an axially-opposed end portions to each of which a stem mount is welded. Each stem mount has an electrode. Each end portion has a ring-shaped end wall and a portion for welding the stem mount located radially inward from an inner edge of the end wall. The phosphor layer is formed on an inner surface of the tubular portion. The base is provided to cover the stem mount. The base, in outside diameter, is smaller than the bulb and larger than the stem mount such that the end wall of the bulb is exposed.

### BACKGROUND OF THE INVENTION

(1) Field of the Invention

The present invention relates to a fluorescent lamp having a bulb whose stem mount is welded to each end portion thereof and a lighting apparatus having the fluorescent lamp.

(2) Description of the Related Art

Fluorescent lamps are widely used as illumination for homes, offices, and workplaces. This is because a fluorescent lamp has higher lamp efficiency than incandescent lamps and can emit light having high color reproducibility. A fluorescent lamp has a structure wherein a phosphor layer is formed on an inner wall of a cylindrical glass bulb and each end of the bulb is sealed with a stem. Leads are inserted in the stem, and electrodes are connected to the leads at end portions thereof inside the glass bulb. In addition, the leads extending outwardly from the glass bulb are connected to base pins, and the base pins are fixed extending outwardly in a tube axis direction of the glass bulb.

When a plurality of fluorescent lamps with the above conventional structure are arranged in series in a longitudinal direction thereof (line illumination), abase of the fluorescent lamp and a socket receiving the base are inserted between the bulbs. Accordingly, when a lighting apparatus includes fluorescent lamps having the conventional structure, it is inevitable that a dark part (non-light-emitting area) is present between the adjacent fluorescent lamps. When a plurality of fluorescent lamps having straight tubes are used for illumination at shops, from the standpoint of appearance, it is demanded that the lamps emit light as if they were one lamp to implement the line illumination.

To meet the above demand, so-called a seamless-type fluorescent lamp as follows is developed. According to the seamless-type fluorescent lamp, base pins connected to electrodes extend from an outer circumferential surface of the glass tube, not in an axis direction of the glass tube, but outwardly in a direction intersecting the tube axis (e.g., Japanese Unexamined Application Publication 2002-329481, Japanese Unexamined Unitility Model Application Publication S61-48548, Japanese Patent No. 3149077, Japanese Patent No. 3816465). Structures pertaining to seamless-type fluorescent lamps pertaining to the prior arts are described with reference to FIGS. 1A and 1B.

First, as shown in FIG. 1A, a seamless-type fluorescent lamp pertaining to a first prior art has a glass bulb 910 (hereinafter, referred to as “bulb”) having an end wall 910b at each end portion thereof, and a phosphor layer 912 is formed on an inner circumferential surface of the bulb 910. In a lateral circumferential wall 910a in the vicinity of the end portion of the bulb 910, an opening 910h is provided, and the opening 910h is sealed with a stem 932 of the stem mount 930.

The stem mount 930 is composed of the stem 932, lead wires 931 and an electrode 933. Two lead wires 931 are inserted in the stem 932 in a thickness direction thereof, and the electrode 933 is suspended between end portions of the lead wires 931 inside the bulb.

Subsequently, as shown in FIG. 1B, a seamless-type fluorescent lamp pertaining to a second prior art has a bulb 960 having an end wall 960b at each end thereof, and a phosphor layer 962 is formed on an inner wall surface of the bulb 960. An auxiliary tube 965 is connected to a lateral circumferential wall 960a of the bulb 960 in the vicinity of the end portion of the bulb 960, and a stem 982 of the stem mount 980 is attached to the auxiliary tube 965.

The structure of the stem mount 982 is similar to that of the stem mount 930. Note that the phosphor layer 962 is formed on the inner wall surface of the glass tube 961 but not formed in the auxiliary tube 965.

According to the seamless-type fluorescent lamp pertaining to the first and second prior arts, as shown in FIGS. 1A and 1B, the base pins extending outwardly in the tube axis direction are not provided on the end walls 910b and 960b of the bulbs 910 and 960. Accordingly, when the fluorescent lamps are arranged in series, the non-light-emitting area between the adjacent fluorescent lamps can be reduced.

However, it has been found that according to the seamless-type fluorescent lamp pertaining to the first and the second prior arts, luminance is low in end areas (areas shown by Arrows C and D) of the bulbs 910 and 960. This is because the phosphor layers 912 and 962 in the areas indicated by the Arrows C and D in FIGS. 1A and 1B are deteriorated in the manufacturing process. That it to say, as shown in FIGS. 1A and 1B, according to the seamless-type fluorescent lamp pertaining to the prior arts, openings 910h and 960h need to be formed in the bulbs 910 and 960, respectively, for fixing therethrough the stem mount 930 and the auxiliary tube 965.

In order to form the openings 910h and 960h in the bulbs 910 and 960, respectively, so-called a blow and break process with use of a burner is employed. Herein, the phosphor layers 912 and 962 have already been formed on inner wall surfaces of the bulbs 910 and 960, respectively, when the openings are formed with the use of the burner. Due to a flame of the burner directed in a direction intersecting the tube axis, in the area of each of the phosphor layers 912 and 962 in the vicinity of a top end of the flame indicated by Arrows C and D and opposing the blown and broken portion of the bulb, which it to say, in the end area of each of the phosphor layers 912 and 962 adjacent to an irradiating surface, deterioration remarkably occurs. Therefore, it has been found that, according to the conventional seamless-type fluorescent lamp, unfortunately, luminance is reduced in the end area and a difference can be made between the central portion and the end portion of the bulb in the longitudinal direction.

### SUMMARY OF THE INVENTION

The present invention is conceived to solve the above problem. It is an object of the present invention to provide a fluorescent lamp and a lighting apparatus having the fluorescent lamp that can reduce the non-light-emitting area of the end portion of the bulb and reduce a difference in luminance between the central portion and the end portion of the bulb in the longitudinal direction.

The present invention provides a fluorescent lamp including: a bulb having a tubular portion and axially-opposed end portions to each of which a stem mount is welded, each stem mount having an electrode, each end portion having (i) a ring-shaped end wall and (ii) a portion for welding the stem mount located radially inward from an inner edge of the end wall; a phosphor layer provided to coat an inner surface of the tubular portion of the bulb; and a base provided to cover each stem mount, wherein the base, in outside diameter, is smaller than the bulb and larger than the stem mount such that the end wall is exposed.

According to the fluorescent lamp pertaining to the present invention, the stem mount is welded to each end portion of the bulb. Therefore, after the blow and break process in which the bulb end portion is blown in the tube axis direction and broken, the flame of the burner does not come close to a portion of the phosphor layer opposing the blown and broken portion. Unlike the seamless-type fluorescent lamp pertaining to the above-mentioned prior art, the present invention can avoid the deterioration problem of the phosphor layer caused by the adjacency between the top end of the flame and the portion of the phosphor layer opposing the blown and broken portion.

In addition, according to the fluorescent lamp pertaining to the present invention, the outside diameter of the base portion covering the stem mount and the welding portion is smaller than the outside diameter of the bulb, and is larger than the outside diameter of the stem mount, and the base portion is provided such that the end wall is exposed. Since the area covered with the base can be reduced to the minimum, the non-light-emitting area of the bulb end portion can be reduced to the minimum, and a portion of the end wall not covered with the base can also efficiently emit light. Thus, the luminance in the end portion of the bulb can be further improved.

Thus, according to the fluorescent lamp pertaining to the present invention, the non-light-emitting area of the end portion can be reduced, and a difference in the luminance between the central portion and the end portion of the bulb in the longitudinal direction can be reduced.

Furthermore, the lighting apparatus pertaining to the present invention has an apparatus body and the above fluorescent lamp attached to the apparatus body.

Since the lighting apparatus pertaining to the present invention has the fluorescent lamp of the present invention, the lighting apparatus can achieve the similar effects. Particularly, when a plurality of fluorescent lamps are arranged in series in the longitudinal direction, the luminance in the end portions of the adjacent fluorescent lamps can be improved. Thus, as line illumination, uniform illumination can be achieved as a whole.

Note that the present invention is not limited to the seamless-type fluorescent lamp. The present invention is also applicable to a conventional type fluorescent lamp wherein a base is fixed at each end of the bulb, and base pins extend outwardly from each base in the tube axis direction. In this case, if a socket of the apparatus body matches the base of the fluorescent lamp, the non-light-emitting area between the adjacent fluorescent lamps can also be reduced.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1A is a cross-section view of a structure of an end portion of a seamless-type fluorescent lamp pertaining to a first prior art;

FIG. 1B is a cross-section view of a structure of an end portion of a seamless-type fluorescent lamp pertaining to a second prior art;

FIG. 2 is an external perspective view of a fluorescent lamp 1 pertaining to an embodiment of the present invention;

FIG. 3 is a cross-section view of a structure of an end portion of the fluorescent lamp 1 pertaining to the embodiment of the present invention;

FIG. 4 is a view showing a relative size relationship among a bulb 10, a stem 30, a phosphor layer 12 and a base 20 of the fluorescent lamp 1 pertaining to the embodiment of the present invention; and

FIG. 5 is a front view of a lighting apparatus pertaining to an embodiment of the present invention.

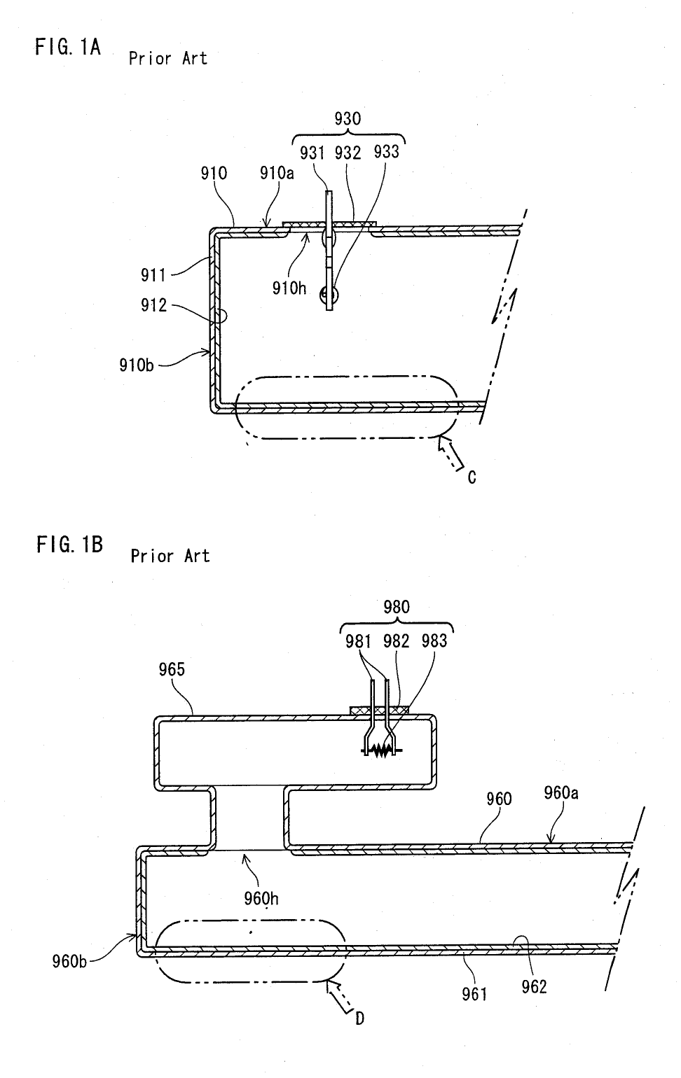

### DESCRIPTION OF THE PREFERRED EMBODIMENT

The following describes the best embodiment for carrying out the present invention using an example. Note that the embodiment described hereafter is only an example to explain structures, functions and effects of the present invention, so that the present invention is never limited to the following embodiment as long as it does not depart from the scope of the essential features of the present invention.

1. Structure of Fluorescent Lamp 1

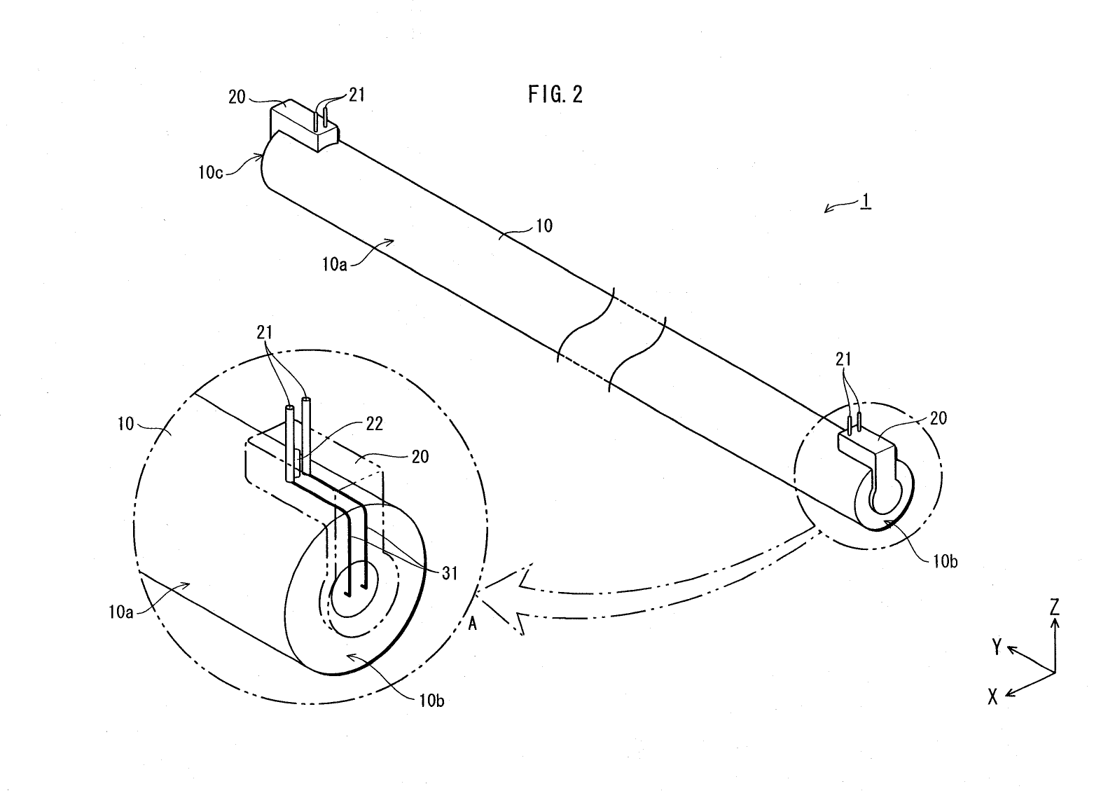

A structure of a fluorescent lamp 1 pertaining to the embodiment of the present invention is described with reference to FIG. 2.

As shown in FIG. 2, the fluorescent lamp 1 pertaining to the embodiment has a cylindrical glass bulb 10 whose tube axis is in a Y axis direction and a base provided at each end portion of the bulb 10 in the Y axis direction. The base 20 at each end portion has two base pins 21 extending outwardly in a Z direction intersecting the tube axis (Y axis) of the glass bulb 10. That is to say, according to the fluorescent lamp 1, the base pins 21 are not installed extending outwardly in the tube axis direction (Y axis direction) of the glass bulb 10, but are installed extending outwardly from a lateral circumferential wall 10a of the glass bulb 10 in a radial direction (Z-axis direction) of the cross section of the glass bulb 10. The fluorescent lamp 1 is so-called a seamless-type fluorescent lamp due to the aforementioned extending structure of the base pins 21.

In addition, as shown in FIG. 2, in a plan view of the fluorescent lamp 1 viewed in an X-axis direction, the base 20 is in a shape of the alphabetical letter L. This is described later.

Furthermore, as shown in a portion encircled by a double-dashed chain in FIG. 2, inside the base 20, an exhaustion pipe 22 extends outwardly from the lateral circumferential wall 10a in the Z-axis direction.

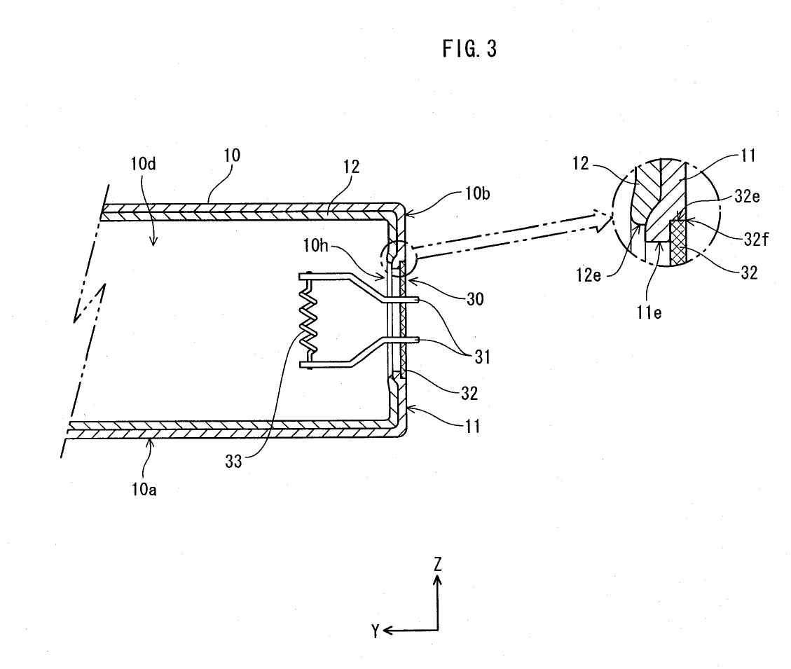

2. Structure of End Portion of Glass Bulb 10 The structure of the end portion of the glass bulb 10 (A portion in FIG. 2) is described with reference to FIG. 3. FIG. 3 shows one end portion of the glass bulb 10. Note that another end portion has a similar structure to the one end portion. As shown in FIG. 3, on the inner circumferential surface of the glass bulb 10 that measures 25.5 [mm] in outside diameter, for example, a phosphor layer 12 is formed. In the central portion of the end portion of the glass bulb 10, a stem mount 32 having an electrode 33 is welded, and end walls 10b and 10c are each formed in the periphery of a welding portion 32f where the stem mount 32 is welded to the end portion. In the boundary between each of the end walls 10b and 10c of the end portion 11 and the stem mount 32, the welding portion 32f is formed. Viewed in the axis direction, each of the end walls 10b and 10c is in a ring shape that is a circular disc having a hole 10h at the center thereof. The ring shape seems like a doughnut or a sword guard. The stem mount 32 is provided being welded to cover the central hole 10h (hereinafter, referred to as “opening”).

The phosphor layer 12 is formed on the inner surface of the lateral circumferential wall 10a (tubular portion) of the glass bulb 10 and the inner surface of each of the end walls 10b and 10c. The phosphor layer 12 is formed in the vicinity of an edge of the opening 10h in each of the end walls 10b and 10c, which is to say, in the vicinity of the outside edge of the stem mount 32. In other words, the phosphor layer 12 extends to further coat an inner surface of each of the end walls 10b and 10c of the bulb 10 such that an inner edge of the phosphor layer 12 is located radially outward from the inner edge of the end wall. A general three-wavelength type phosphor is used for the phosphor.

The stem mount 32 is made of a button stem 30 in a circular planar shape that measures 12.5 [mm] in outside diameter, for example, two lead wires 31 inserted in the button stem 30 in a thickness direction thereof, and the electrode 33 suspended between the end portions of the lead wires 31, the end portions being located close to the internal space of the glass bulb 10.

Inside an internal space (discharge space) 10d of the glass bulb 10, mercury (Hg), and an argon gas (Ar) or the like are enclosed as rare gases.

As shown in a portion encircled by the double-dashed chain in FIG. 3, an inner edge lie of the opening 10h of the glass bulb 10 is radially inward from an outer edge 32e of the button stem 30 of the stem mount 32. That is to say, an opening diameter of the opening 10h is smaller than an outside diameter of the button stem 30. In addition, a diameter of an inner edge 12e of the phosphor layer 12 formed on the inner surface of each of the end walls 10b and 10c is larger than a diameter of the inner edge lie of the opening 10h.

According to the fluorescent lamp 1, the lead wires 31 are led from the button stem 30 of the stem mount 32, and bent along an outer surface of the button stem 30 substantially at a root thereof. The lead wires 31 extend along the outer surface of the button stem 30, the end walls 10b and 10c and the outer surface of the lateral circumferential wall 10a of the glass bulb 10. Another end of each of the lead wires 31 is connected to one of the base pins 21 (see FIG. 2).

At the end portion 11 of the glass bulb 10, covering the stem mount 32 and the welding portion 32f, the base 20 covers the lead wires 31 extending along the surface of the glass bulb 10. The base 20 is provided in a state where the end walls 10b and 10c are exposed viewed in the tube axis direction.

3. Structure of Base 20

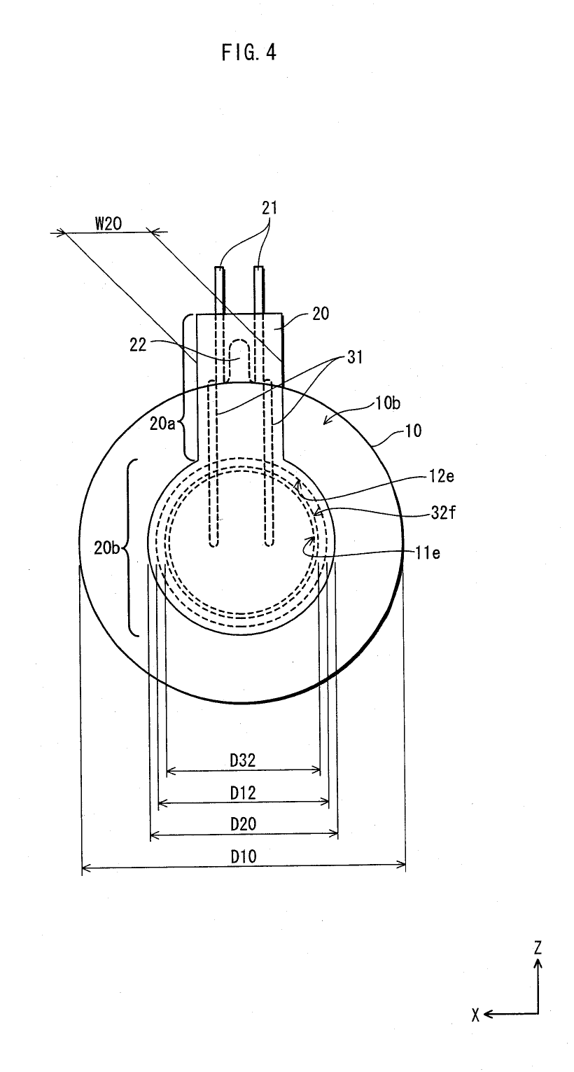

A structure and a size of the base 20 are described with reference to FIG. 4.

As shown in FIG. 4, the base 20 includes a circular base portion 20b (hereinafter, described as “first base portion”) that covers the stem mount 32 and the welding portion 32f. In addition, the base 20 may be composed of integration of this first base portion and another base portion 20a (hereinafter described as “second base portion”) whose width is narrower than an outside diameter D20 of this first base portion to cover the lead wires 31. In this case, the over all shape of the base 20 is in the letter L. Accordingly, a contacting area of the base 20 and the glass bulb 10 can be large, which provides sufficiently strong adhesion therebetween.

In addition, the narrower width of the second base portion 20a than the first base portion 20b can contribute to reduce an area of the second base portion 20a located above an end portion 11. Accordingly, a portion of a light-emitting area of each of the end walls 10b and 10c blocked by the second base portion 20a can be reduced. Thus, the light emitting area of each of the end walls 10b and 10c can be large. Note that the second base portion 20a of the base 20 is sufficient if a width W20 of the second base portion 20a is set to the minimum to cover the two lead wires 31 extending along the end walls 10b and 10c.

In addition, the base 20 may be made of a transparent resin material. For example, when a transparent base is used, the portion of the light-emitting area blocked by the base 20 can effectively emit light to the outside, which enhances luminance in the end portion of the fluorescent lamp 1.

The outside diameter D20 of the first base portion 20b of the base 20 is kept smaller than the outside diameter D10 of the end wall 10b of the glass bulb 10 so that the end walls 10b and 10c are exposed, which is to say, light can be extracted from the end walls 10b and 10c. The outside diameter D20 of the first base portion 20b is larger than the outside diameter D32 of the outer edge 32e of the stem mount 32a or the welding portion 32f. In addition, the outside diameter D20 of the first base portion 20b is larger than the inside diameter D12 of the inner edge 12e of the phosphor layer 12 formed on the inner surface of each end wall 10b and 10. That is to say, since the base 20 also covers the end edge of the phosphor layer 12 formed on each end wall 10b and 10c, the end edge being closer to the stem mount 32, the appearance quality of the end portion can be improved.

4. Lighting Apparatus

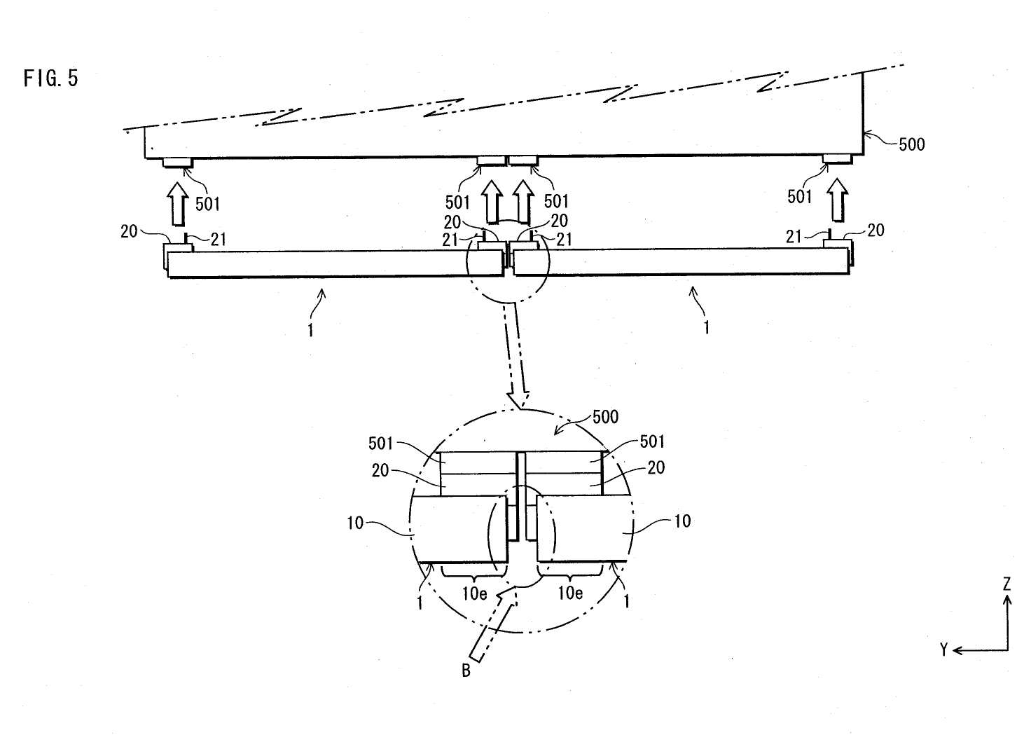

A lighting apparatus including the fluorescent lamp 1 pertaining to the embodiment as an element of the present invention is described with reference to FIG. 5.

As shown in FIG.5, the lighting apparatus pertaining to the embodiment has, for example, an apparatus body 500, and two fluorescent lamps 1. The two fluorescent lamps 1 are arranged in series. The lighting apparatus has four sockets fixed on the apparatus body 500. The four sockets fixed on the apparatus body 500 each receive one of the base pins 21 of the fluorescent lamp 1. Therefore, the four sockets 501 are arranged in series in the Y-axis direction.

According to the lighting apparatus of the embodiment, the base pins 21 of each of the two fluorescent lamps 1 are inserted in the socket 501 of the apparatus body 500 so that the two fluorescent lamps 1 are arranged in series. In this case, as shown in the portion encircled by the double-dashed chain in FIG.5, a gap between the adjacent fluorescent lamps 1 in a longitudinal direction (Y-axis direction) can be narrower than that between conventional fluorescent lamps each having a base at each end portion in the longitudinal direction.

In addition, described as above, according to the fluorescent lamp 1, since the base 20 is made of a transparent resin material, light is also emitted from a portion indicated by the Arrow B. Thus, the lighting apparatus pertaining to the embodiment has few variances in the luminance and presents a good appearance.

The above embodiment is described by way of example of so-called a seamless-type fluorescent lamp used for the line illumination having the base pins 21 extending in a direction (substantially orthogonal) intersecting the tube axis of the glass bulb 10. However, the present invention is not limited to this, and is also applicable to a general fluorescent lamp conventionally and widely in use. In this case as well, the end portion of the glass bulb also illuminates strongly, and the lamp is excellent from the standpoint of mass productivity, appearance quality, strength and the like.

In addition, the above embodiment employs a straight-tube fluorescent lamp 1 as the example. However, needless to say, the present invention is also applicable to a ring-shaped fluorescent lamp. When the present invention is applied to the ring-shaped fluorescent lamp, non-light-emitting areas between the end portions of the glass bulbs can also be reduced, which does not cause reduction in the luminance in the end portion of the glass bulb. Thus, the present invention is excellent from the standpoint of appearance.

In addition, according to the above embodiment, a button-shaped stem 30 is employed. However, the present invention does not necessarily employ the button-shaped stem and may employ a flare-shaped stem whose diameter is smaller than the outside diameter D10 of the glass bulb 10. Note that, in this case, an area of each of the end walls 10b and 10c is formed as large as possible, and that the phosphor layer 12 is additionally formed on the inner surface of the area of the end walls 10b and 10c.

In addition, according to the above embodiment, the phosphor layer 12 is not formed on the inner surface of the stem 30 which is a surface of the stem 30 closer to the discharge space. Thus, the present invention holds superiority in that it is possible to visually check from the outside that the electrodes 33 and the inner surface of the glass bulb 10 are out of contact with each other after the welding of the stem 30. However, according to the fluorescent lamp of the present invention, the phosphor layer 12 may be additionally formed on the inner surface of the stem 30. In this case, when the transparent base 20 is also employed in the fluorescent lamp 1, the phosphor layer 12 formed on the inner surface of the stem 30 contributes to improve the luminance of the glass bulb.

In addition, according to the above embodiment, the phosphor material is employed as a constituent material of the phosphor layer 12. However, the present invention is not limited to this. The constituent material may be appropriately changed to a general phosphor material used for manufacturing a fluorescent lamp. For example, as long as the material of the bulb is transparent, the material is not limited to glass, and the phosphor material is not limited to the above.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be constructed as being included therein.

What is claimed is:

1. A fluorescent lamp comprising:
a bulb having a tubular portion and axially-opposed end portions to each of which a stem mount is welded, each stem mount having an electrode, each end portion having (i) a ring-shaped end wall and (ii) a portion for welding the stem mount located radially inward from an inner edge of the end wall;
a phosphor layer provided to coat an inner surface of the tubular portion of the bulb; and
a base provided to cover each stem mount, wherein the base, in outside diameter, is smaller than the bulb and larger than the stem mount such that the end wall is exposed.

2. The fluorescent lamp of claim 1, wherein
the base further covers each welding portion.

3. The fluorescent lamp of claim 1, wherein
the phosphor layer extends to further coat an inner surface of each end wall of the bulb such that an inner edge of the phosphor layer is located radially outward from the inner edge of the end wall, and
the base further covers a portion of each end wall corresponding to the inner edge of the phosphor layer.

4. The fluorescent lamp of claim 1, wherein
the stem mount has a pair of lead wires each connected to the electrode at one end thereof,
an other end of each lead wire is led from the stem mount in a tube axis direction,
the lead wire has an extending portion extending from the stem mount along the end wall to an outer circumferential surface of the bulb,
the base has a first portion and a second portion, and
in a plan view of the end portion of the bulb that is externally viewed in the tube axis direction, the first portion covers the stem mount and the welding portion, and the second portion covers the extending portion of the lead wire.

5. The fluorescent lamp of claim 4, wherein
the first portion and the second portion are integral to form the base.

6. The fluorescent lamp of claim 4, wherein
the base has a pair of base pins thereon extending outwardly in a direction intersecting the tube axis, and
each base pin is connected to a top end of the extending portion of the lead wire.

7. The fluorescent lamp of claim 1, wherein
when the base is viewed in a direction orthogonal to the tube axis, the base is L-shaped.

8. The fluorescent lamp of claim 1, wherein
the base is made of a transparent resin material.

9. The fluorescent lamp of claim 1, wherein
a main body of the stem mount is in a plate-like shape.

10. A lighting apparatus having an apparatus body and a fluorescent lamp attached to the apparatus body, the fluorescent lamp comprising:
a bulb having a tubular portion and axially-opposed end portions to each of which a stem mount is welded, each stem mount having an electrode, each end portion having (i) a ring-shaped end wall and (ii) a portion for welding the stem mount located radially inward from an inner edge of the end wall;
a phosphor layer provided to coat an inner surface of the tubular portion of the bulb; and
a base provided to cover each stem mount, wherein
the base, in outside diameter, is smaller than the bulb and larger than the stem mount such that the end wall is exposed.

11. The lighting apparatus of claim 10, wherein
the base further covers each welding portion.

12. The lighting apparatus of claim 10, wherein
the phosphor layer extends to further coat an inner surface of each end wall of the bulb such that an inner edge of the phosphor layer is located radially outward from the inner edge of the end wall, and
the base further covers a portion of each end wall corresponding to the inner edge of the phosphor layer.

13. The lighting apparatus of claim 10, wherein
the stem mount has a pair of lead wires each connected to the electrode at one end thereof,
an other end of each lead wire is led from the stem mount in a tube axis direction,
the lead wire has an extending portion extending from the stem mount along the end wall to an outer circumferential surface of the bulb,
the base has a first portion and a second portion, and
in a plan view of the end portion of the bulb that is externally viewed in the tube axis direction, the first portion covers the stem mount and the welding portion, and the second portion covers the extending portion of the lead wire.

14. The lighting apparatus of claim 13, wherein
the first portion and the second portion are integral to form the base.

15. The lighting apparatus of claim 13, wherein
the base has a pair of base pins thereon extending outwardly in a direction intersecting the tube axis, and
the base pin is connected to a top end of the extending portion of the lead wire.

16. The lighting apparatus of claim 10, wherein
when the base is viewed in a direction orthogonal to the tube axis, the base is L-shaped.

17. The lighting apparatus of claim 10, wherein
the base is made of a transparent resin material.

18. The lighting apparatus of claim 10, wherein
a main body of the stem mount is in a plate-like shape.

19. The lighting apparatus of claim 10, wherein
the apparatus body has therein a plurality of fluorescent lamps arranged in a longitudinal direction of the lamps.
